(19) United States
(12) Patent Application Publication
(10) Pub. No.: US 2026/0070135 A1
(43) Pub. Date: Mar. 12, 2026

(54) CUTTING INSERT AND MILLING TOOL

(71) Applicant: TUNGALOY CORPORATION, Fukushima (JP)

(72) Inventors: Syuji KAMEDA, Iwaki-shi (JP); Satoru YOSHIDA, Iwaki-shi (JP)

(73) Assignee: TUNGALOY CORPORATION, Fukushima (JP)

(21) Appl. No.: 19/106,679

(22) PCT Filed: Jan. 31, 2024
(86) PCT No.: PCT/JP2024/003090

§ 371 Date: Feb. 26, 2025

(30) Foreign Application Priority Data
Jan. 31, 2023 (JP) 2023-012699

(51) Int. Cl. B23C 5/20

(52) U.S. Cl. CPC B23C 5/20

(57) ABSTRACT

A compact cutting insert that can make tool bodies in common and a milling tool using the cutting insert are provided.

The cutting insert (10) has an upper surface (20) and a lower surface (40) on a side opposite to the upper surface (20), and a peripheral side surface (30) that connects the upper surface (20) and the lower surface (40). An edge (11) where the upper surface (20) and the peripheral side surface (30) intersect includes at least one cutting edge (14). The peripheral side surface (30) includes a flank (31) adjacent to the at least one cutting edge (14), a thickness-reduced surface (33) adjacent to the flank (31) from the lower surface (40) side, and a contact surface (32) adjacent to the thickness-reduced surface (33) from the lower surface side. In a section cut out on a plane including a central axis (O), an angle (β) formed by a virtual plane (V) parallel to the central axis (O) passing through a center of the upper surface (20) and a center of the lower surface (40) and passing through the at least one cutting edge (14) and the contact surface (32) is larger than an angle (γ) formed by the virtual plane (V) and the thickness reduced surface (33).

### TECHNICAL FIELD

The present invention relates to a cutting insert and a milling tool using the cutting insert.

### BACKGROUND ART

Patent Literature 1 discloses an art of forming a flat contact surface by providing a stepped part between a major flank and the contact surface on a side surface.

### CITATION LIST

### Patent Literature

Patent Literature 1: Patent Publication JP-A No. 2015-100901

### SUMMARY OF INVENTION

### Technical Problem

However, if a stepped part extends in a diameter direction, a size of a cutting insert is increased for that portion and thus, a new problem might be generated in some cases. For example, if the shapes of the contact surfaces are in common, various cutting inserts with different shapes of edge parts can be fixed to a common tool body, but if the edge part is extremely larger than the contact surface, even if the shape of the contact surface is in common with the shapes of the other cutting inserts, the edge parts interfere, and the common tool body cannot be used anymore.

Thus, the present invention has an object to provide a compact cutting insert that can make a tool body in common and a milling tool using the cutting insert.

### Solution to Problem

A cutting insert according to an Embodiment of the present invention has an upper surface, a lower surface on a side opposite to the upper surface and a peripheral side surface connecting the upper surface and the lower surface. An edge where the upper surface and the peripheral side surface intersect includes at least one cutting edge. The peripheral side surface includes a flank adjacent to at least one cutting edge, a thickness-reduced surface adjacent to the flank from a lower surface side, and the contact surface adjacent to the thickness-reduced surface from the lower surface side. In a section orthogonal to the cutting edge, an angle formed by a virtual plane parallel to a central axis passing through a center of the upper surface and a center of the lower surface and passing through at least one cutting edge and the contact surface is larger than an angle formed by the virtual plane and the thickness-reduced surface.

According to this Embodiment, since the thickness-reduced surface with an angle smaller than the contact surface is provided, the contact surface does not protrude in a radial direction from the cutting edge at a position of the thickness-reduced surface even without increasing the size of the cutting insert. A compact cutting insert which can make the tool body in common can be constituted.

In the aforementioned Embodiment, in a state of being mounted on the tool body, the contact surface is in contact with the tool body, and the thickness-reduced surface does not have to be in contact with the tool body.

In this Embodiment, since the thickness-reduced surface is not a retainer that regulates rotation of the cutting insert, there is no need to bring the thickness-reduced surface into contact with the tool body.

In the aforementioned Embodiment, an upper surface may be a substantial polygon rotationally symmetric with respect to the central axis and have a plurality of corners including a first corner and a second corner adjacent to each other. The thickness-reduced surface may be formed at a position facing an intermediate position between the first corner and the second corner on the peripheral side surface.

According to this Embodiment, even at the intermediate position between the first corner and the second corner where the contact surface and the flank are the closest to each other, the thickness-reduced surface whose angle is smaller than that of the contact surface is formed at the position and thus, the contact surface does not protrude in the radial direction from the cutting edge.

In the aforementioned Embodiment, the contact surface is a substantially conical surface or a substantially columnar surface, and the thickness-reduced surface may be formed into a substantially flat surface.

According to this Embodiment, a tool body, which is in common with various cutting inserts including a round insert whose contact surface is a conical surface or a columnar surface can be used.

A milling tool according to another Embodiment of the present invention includes a tool body and a cutting insert on which the tool body is mounted. The cutting insert has an upper surface, a lower surface on a side opposite to the upper surface, and a peripheral side surface connecting the upper surface and the lower surface. An edge where the upper surface and the peripheral side surface intersect includes at least one cutting edge. The peripheral side surface includes a flank adjacent to the at least one cutting edge, a thickness-reduced surface adjacent to the flank from the lower surface side, and a contact surface adjacent to the thickness-reduced surface from the lower surface side. The tool body is in contact with the contact surface and is not in contact with the thickness reduced surface.

According to this Embodiment, the milling tool can be constituted by using the cutting insert exerting the aforementioned excellent effects.

### Advantageous Effect of Invention

According to the present invention, a compact cutting insert that can make a tool body inn common and a milling tool using the cutting insert can be provided.

### BRIEF DESCRIPTION OF DRAWINGS

FIG. 1 is a perspective view illustrating an example of a milling tool on which a cutting insert of an Embodiment of the present invention is mounted.

FIG. 2 is a perspective view illustrating an insert mounting seat with the cutting insert removed.

FIG. 3 is a perspective view illustrating an example of a cutting insert of an Embodiment of the present invention.

FIG. 4 is a plan view of the cutting insert illustrated in FIG. 3 when viewed from an upper surface side.

FIG. 5 is a bottom view of the cutting insert illustrated in FIG. 3 when viewed from a lower surface side.

FIG. 6 is a side view when viewed from a radial direction orthogonal to a VII-VII line in FIG. 4.

FIG. 7 is a sectional view along a VII-VII line in FIG. 4.

FIG. 8 is a side view when viewed from the radial direction orthogonal to IX-IX line in FIG. 4.

FIG. 9 is a sectional view along the IX-IX line in FIG. 4.

### DESCRIPTION OF EMBODIMENTS

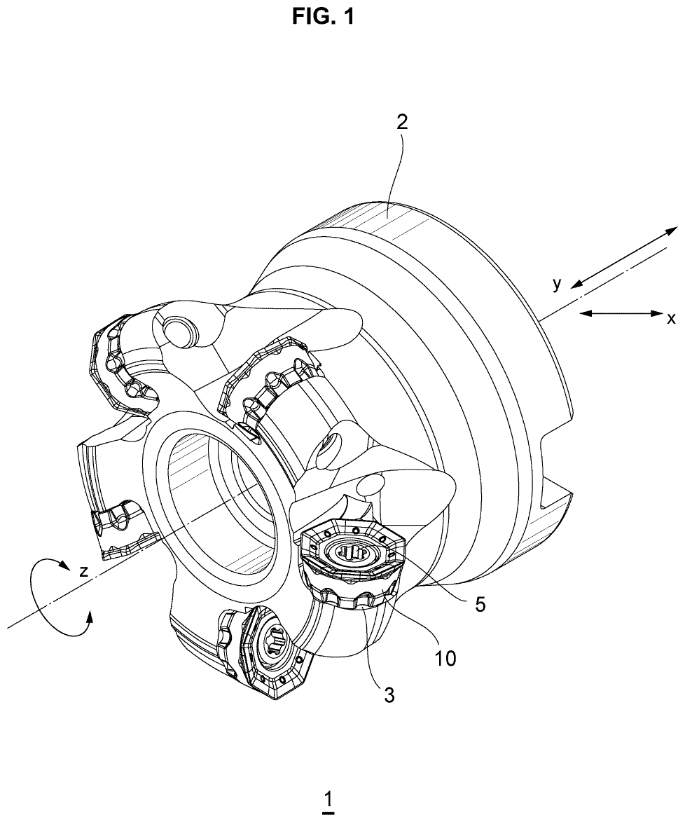

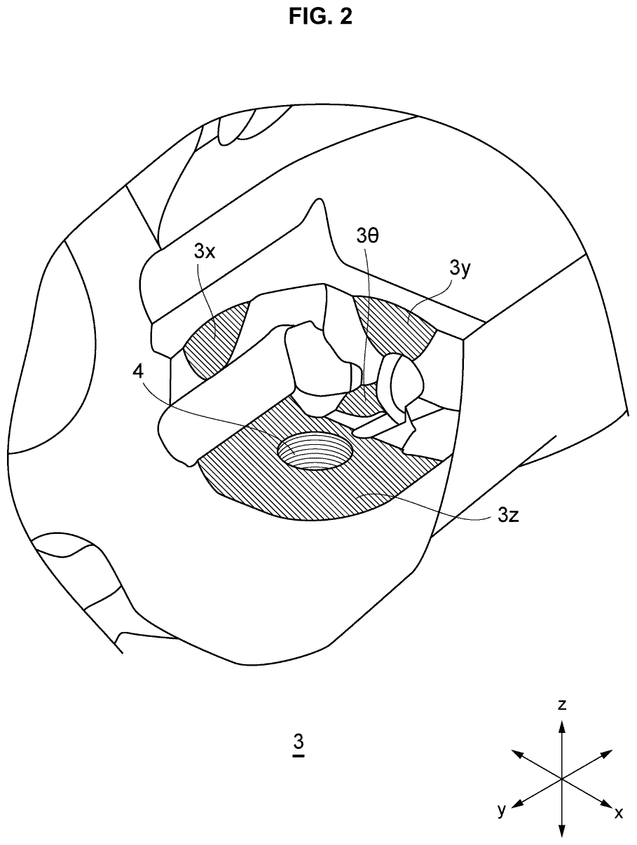

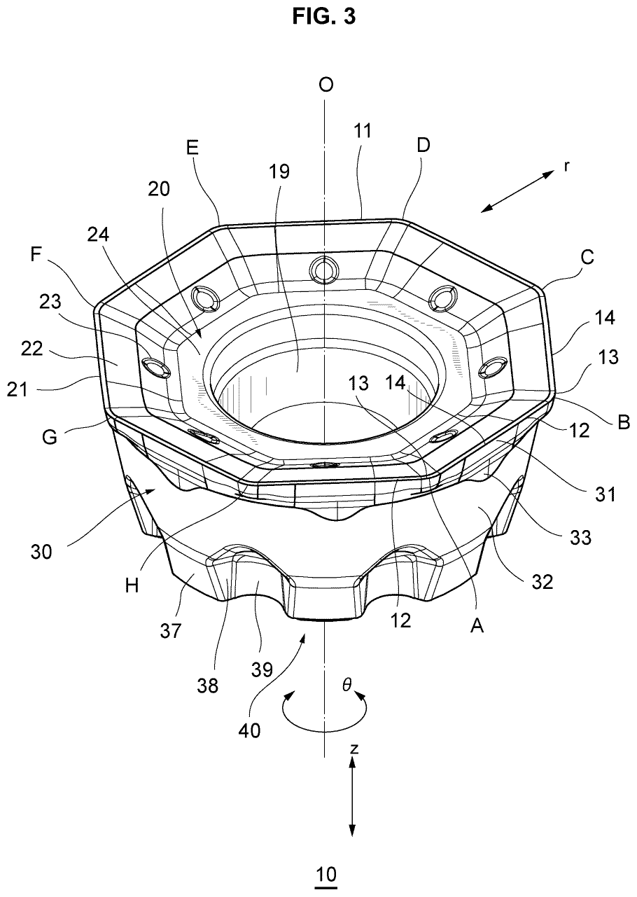

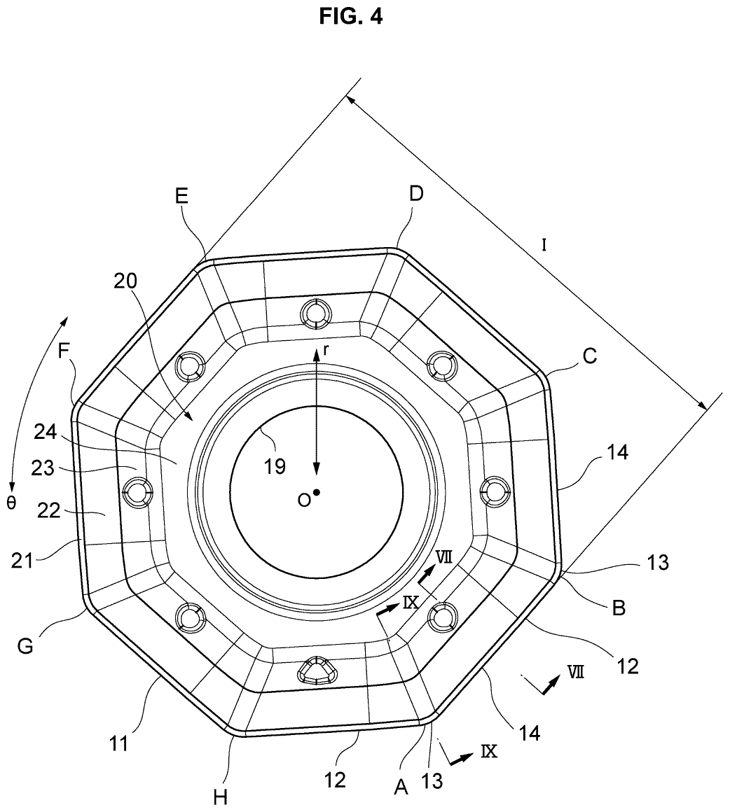

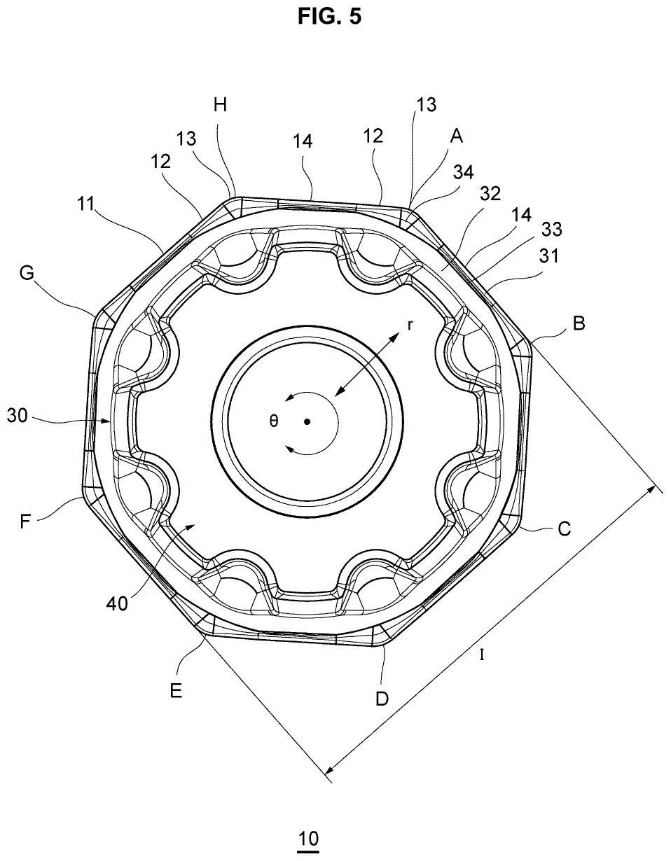

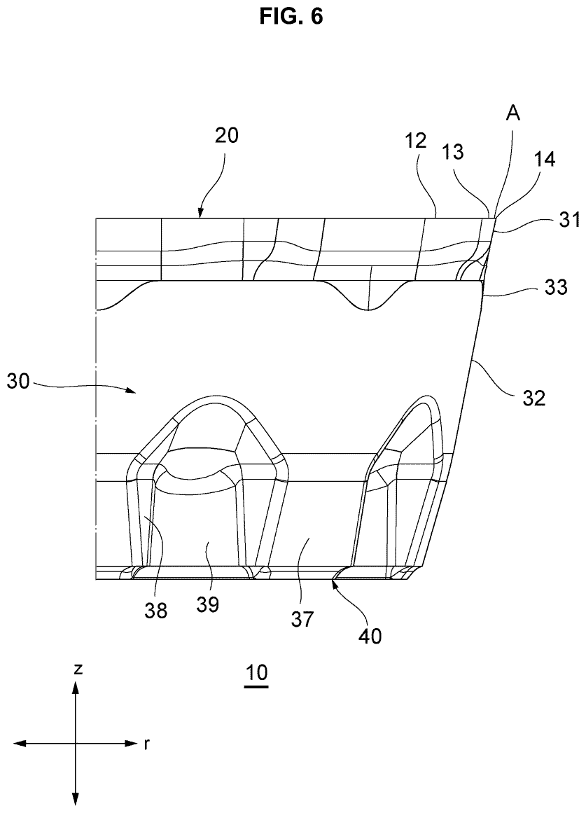

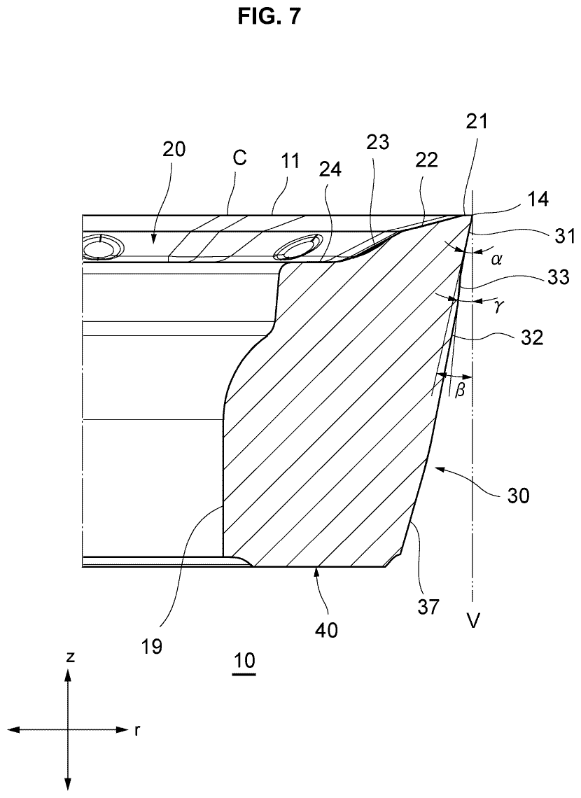

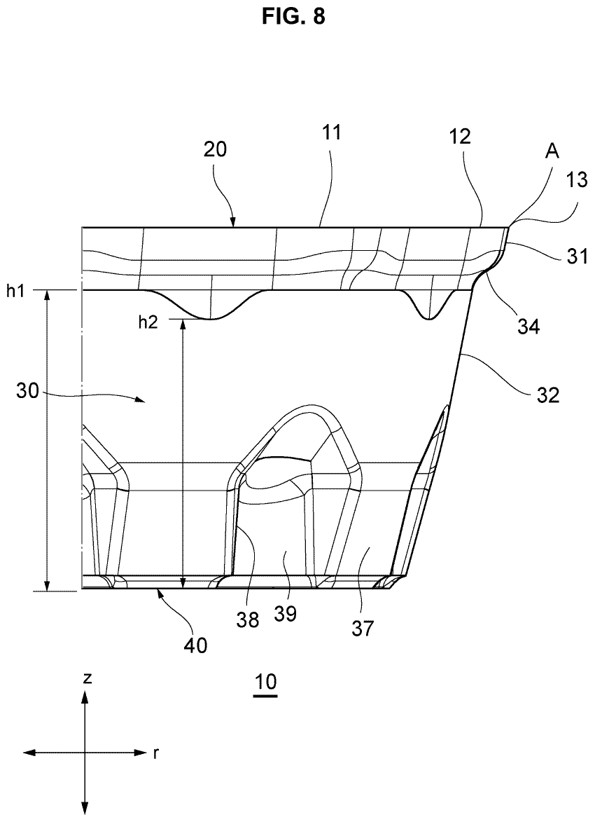

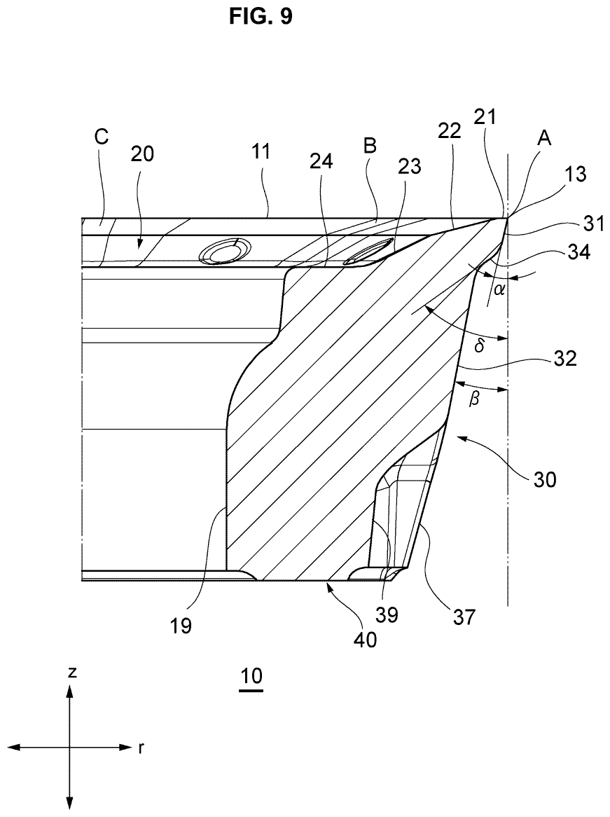

With reference to the attached drawings, preferred embodiments of the present invention will be explained. Note that, in each drawing, those with the same signs have the same or similar configurations. A cutting insert 10 in an Embodiment of the present invention is, as shown in FIG. 1 and FIG. 2, a cutting insert which can be mounted on a tool body 2, and as shown in FIG. 3, FIG. 8, and FIG. 9, an edge part (in an illustrated example, a major cutting edge 14, a first rake surface 21, a second rake surface 22, and a flank 31) extends from a contact surface 32 in contact with the tool body 2. However, as shown in FIG. 6 and FIG. 7, since a part of the contact surface 32 is retreated to a central axis O side of the cutting insert 10, and a thickness-reduced surface 33 is provided, as shown in FIG. 4 and FIG. 5, a size of the cutting insert 10, that is, a size increase of a diameter I of an inscribed circle of an upper surface 20 can be suppressed. Hereinafter, with reference to the drawings, each configuration will be explained in detail.

FIG. 1 is a perspective view illustrating an example of an indexable milling tool 1 on which the cutting insert 10 of an Embodiment of the present invention is mounted. As shown in FIG. 1, the milling tool 1 is a front-surface milling tool and includes the tool body 2 formed having a cylindrical shape or a disc shape and at least one cutting insert 10 mounted on an outer peripheral part of the tool body 2. Each of the cutting inserts 10 is fixed to an insert mounting seat 3 of the tool body 2 by a fastening screw 5 and the like.

FIG. 2 is a perspective view illustrating the insert mounting seat 3 shown in FIG. 1 by removing the cutting insert 10. In the insert mounting seat 3, a screw hole 4 screwed with the fastening screw 5, first to third contact surfaces 3x, 3y, 3z, which are brought into contact with the cutting insert 10 from three directions, that is, a radial direction x, an axial direction y, and a circumferential direction z of the tool body 2 and regulate movement, a fourth contact surface 3θ which regulates rotation of the screwed cutting insert 10 and the like are provided.

FIG. 3 is a perspective view illustrating an example of the cutting insert 10 of the Embodiment of the present invention. As shown in FIG. 3, the cutting insert 10 has the upper surface 20, a lower surface 40 on the side opposite to the upper surface 20, a peripheral side surface 30 connecting the upper surface 20 and the lower surface 40, and a mounting hole 19 penetrating the upper surface 20 and the lower surface 40. A central axis of the mounting hole 19 matches the central axis O of the cutting insert 10 passing through the center of the upper surface 20 and the center of the lower surface 40.

In the following explanation, a direction parallel to the central axis O shall be referred to as an axial direction (up-down direction) z of the cutting insert 10. In the axial direction z, a direction from the lower surface 40 to the upper surface 20 shall be referred to as upward, and a direction from the upper surface 20 to the lower surface 40 as downward. In addition, a direction orthogonal to the central axis O shall be referred to as a radial direction r of the cutting insert 10, and a direction following a circumference around the central axis O shall be referred to as a circumferential direction θ of the cutting insert 10.

In the illustrated example, the cutting insert 10 is constituted by a three-stage structure including an upper stage formed having a substantially polygonal disc shape, an intermediate stage formed having a substantially truncated cone, and a lower stage on which a projected part 37 and a recessed part 39 are formed. In a state where the cutting insert 10 is mounted on the tool body 2, the lower surface 40 is brought into contact with the aforementioned third contact surface 3z. The contact surface 32 formed on the intermediate stage is in contact with the first and second contact surfaces 3x, 3y of the aforementioned tool body 2. A stepped surface (retainer) 38 connecting the projected part 37 and the recessed part 39 formed on the lower stage is in contact with the aforementioned fourth contact surface 30.

On the other hand, the thickness-reduced surface 33, which will be described later, is not a retainer which regulates rotation of the cutting insert 10 in the peripheral direction θ and thus, in a state where the cutting insert 10 is mounted on the tool body 2, it is not brought into contact with the insert mounting seat 3 of the tool body 2.

In the illustrated example, the upper surface 20 has the first rake surface 21, the second rake surface 22, a third rake surface 23, a flat surface 24 and the like. The first rake surface 21 is adjacent to an edge 11. The first rake surface 21 with a small width, adjacent to the edge 11, may be referred to as a land. The second rake surface 22 is adjacent to the first rake surface 21 from the side opposite to the edge 11, and the third rake surface 23 is adjacent to the second rake surface 22 from the side opposite to the first rake surface 21. The flat surface 24 is formed parallel to the radial direction r orthogonal to the central axis O (see FIG. 7 and FIG. 9).

FIG. 4 is a plan view of the cutting insert 10 shown in FIG. 3 viewed from the upper surface 20 side. As shown in FIG. 4, the upper surface 20 is formed in a substantial polygon, which is rotationally symmetric with respect to the central axis O, and has a plurality of corners A, B, C, . . . for example. In the illustrated example, it is formed having a substantially octagonal shape of eight-fold symmetry. The shape of the upper surface 20 is not limited to the illustrated example but may be a substantial polygon other than the substantial octagon. In the following explanation, the corners A, B adjacent to each other are referred to as a first corner A and a second corner B in some cases.

The edge 11 where the upper surface 20 and the peripheral side surface 30 intersect each other is divided into a plurality of sections (sides of a polygon) AB, BC, CD, . . . corresponding to a plurality of the corners A, B, C, . . . on the one-to-one basis. On each of the plurality of sections AB, BC, CD, . . . the major cutting edge 14, which is an example of the cutting edge, is formed individually. In the illustrated example, the major cutting edge 14 is formed linearly. The edge 11 may further include a wiper edge 12 and a corner cutting edge 13 in addition to the major cutting edge 14.

In the illustrated example, the corner cutting edge 13 curved in an arc shape is formed at each of the corners A, B, C, . . . and the wiper edge 12 is formed on a side opposite to the major cutting edge 14 with the corner cutting edge 13 between them. The major cutting edge 14 is the longest in a set of the cutting edges 11, 12, 13 and is formed longer than the wiper edge 12 and the corner cutting edge 13.

The wiper edge 12 is a cutting edge having a role of reducing roughness of a machined bottom-surface and is also referred to as a sub cutting edge. The wiper edge 12 is disposed in a direction substantially orthogonal to the rotational axis of the milling tool 1 in a state where the cutting insert 10 is mounted on the tool body 2. The major cutting edge 14 is disposed on an outer side farther from the rotational axis of the milling tool 1 than the wiper edge 12 in a state where the cutting insert 10 is mounted on the tool body 2.

FIG. 5 is a bottom view of the cutting insert 10 shown in FIG. 3, viewed from the lower surface 40 side. As shown in FIG. 3 and FIG. 5, the peripheral side surface 30 connecting the upper surface 20 and the lower surface 40 includes, in a region corresponding to each of the plurality of sections AB, BC, CD, . . . on the one-to-one basis, the flank 31 adjacent to the major cutting edge 14, the thickness-reduced surface 33 adjacent to the flank 31 from the lower surface 40 side, that is, from below, and the contact surface 32 adjacent to the thickness-reduced surface 33 from the lower surface 40 side, that is, from below.

In the illustrated example, the contact surface 32 is formed into a conical surface, the thickness-reduced surface 33 into a substantially flat surface or strictly speaking, a conical surface with an extremely large radius of curvature. The shape of the contact surface 32 is not limited to the substantially conical surface but may be a substantially columnar shape or the other shapes.

As shown in FIG. 5, a profile of the lower surface 40 is substantially circular except the recessed part 39, and a profile of the upper surface 20 is a substantial polygon larger than the lower surface 40. In the radial direction r of the cutting insert 10, the thickness-reduced surface 33 is formed at an intermediate position between the corner A and the corner B, at which an upper edge of the contact surface 32 and the flank 31 are the closest to each other. Thus, the upper edge of the contact surface 32 does not protrude in the radial direction r than the major cutting edge 14, even without increasing the diameter I of the inscribed circle of the upper surface 20.

FIG. 6 is a side view when viewed from the radial direction orthogonal to a VII-VII line in FIG. 4. FIG. 7 is a sectional view along the VII-VII line in FIG. 4. The section shown in FIG. 7 is an example of a section cut out on a plane including the central axis O and is orthogonal to the major cutting edge 14 at a substantially intermediate position between the corner A and the corner B shown in FIG. 4.

As shown in FIG. 6 and FIG. 7, the first and second rake surfaces 21, 22 and the flank 31 are located so as to sandwich the major cutting edge 14. The major cutting edge 14, the first rake surface (land) 21, the second rake surface 22, and the flank 31 constitute the edge part (14, 21, 22, 31) on the upper stage of the cutting insert 10.

When a virtual plane V passing through the major cutting edge 14 and parallel to the central axis O, that is, a machined surface of a workpiece is assumed, an angle β formed by the virtual plane V and the contact surface 32 is larger than an angle γ formed by the virtual plane V and the thickness-reduced surface 33, which is a size relation of γ<β. In addition, a clearance angle α formed by the virtual plane V and the flank 31 is larger than the angle β formed by the virtual plane V and the contact surface 32, which is a size relation of γ<β<α. When the clearance angle α is made larger, it becomes difficult to bite chips into a space between the machined surface of the workpiece indicated as the virtual plane V in FIG. 7 and the flank 31.

FIG. 8 is a side view when viewed from the radial direction orthogonal to an IX-IX line in FIG. 4. FIG. 9 is a sectional view along the IX-IX line in FIG. 4 and is a section cut out on a plane including the central axis O and the corner A. As shown in FIG. 8 and FIG. 9, the peripheral side surface 30 has an extended surface 34 connecting the contact surface 32 and the flank 31 at the corner A and its vicinity. An angle δ formed by the virtual plane V and the extended surface 34 is larger than the angle β formed by the virtual plane V and the contact surface 32, which is a size relation of β<δ.

In a region adjacent to the extended surface 34, the contact surface 32 has a constant height h1 from the lower surface 40 to the upper edge of the contact surface 32. In a region adjacent to the thickness-reduced surface 33, a height h2 from the lower surface 40 to the upper edge of the contact surface 32 is lower than the aforementioned constant height h1.

According to the cutting insert 10 constituted as above and the milling tool 1 using the cutting insert 10, the cutting edge (major cutting edge 14) can be constituted in various shapes even without increasing the diameter I of the inscribed circle of the upper surface 20. Since the size of the cutting insert 10 is compact, the edge part (major cutting edge 14, the rake surfaces 21, 22, the flank 31 and the like) does not interfere with the insert mounting seat 3. Various cutting inserts including the round insert and the tool body 2 can be made common.

The aforementioned Embodiment is for facilitating understanding of the present invention and is not intended to interpret the present invention in a limited manner. Each element and a disposition, a material, a condition, a shape, a size and the like thereof included in the Embodiment are not limited to those exemplified but can be changed as appropriate. In addition, configurations illustrated in different Embodiments can be partially replaced or combined.

For example, the shape of the upper surface 20 is not limited to the substantial polygon but may be an ellipse or an egg shape. By forming the thickness-reduced surface 33 at a position where the upper surface 20 and the upper edge of the contact surface 32 are the closest to each other on the plan view, even if the upper surface 20 is a substantial polygon, an ellipse or an egg shape, the other types of the cutting inserts and the tool body 2 can be made in common without increasing the size of the cutting insert 10.

### Reference Signs List

1 Milling tool

2 Tool body

3 Insert mounting seat

3x, 3y, 3z, 3θ First to fourth contact surfaces on tool body side

4 Screw hole

5 Fastening screw

10 Cutting insert

11 Edge

12 Wiper edge

13 Corner cutting edge

14 Major cutting edge (one example of cutting edge)

19 Mounting hole

20 Upper surface

21 First rake surface

22 Second rake surface

23 Third rake surface

24 Flat surface

31 Flank

32 Contact surface

33 Thickness-reduced surface

34 Extended surface

37 Projected part

38 Stepped surface

39 Recessed part

40 Lower surface

A to H Corner

h1, h2 Height of upper edge of contact surface

I Diameter of inscribed circle

O Central axis

r Radial direction of cutting insert

V Virtual plane (machined surface of workpiece)

x Radial direction of tool body

y Axial direction of tool body

z Axial direction of cutting insert (peripheral direction of tool body)

θ Peripheral direction of cutting insert

α Clearance angle

β Angle of contact surface

γ Angle of thickness-reduced surface

δ Angle of extended surface

1. A cutting insert, comprising:
an upper surface, a lower surface on a side opposite to the upper surface, and a peripheral side surface that connects the upper surface and the lower surface, wherein
an edge where the upper surface and the peripheral side surface intersect includes at least one cutting edge;
the peripheral side surface includes a flank adjacent to the at least one cutting edge, a thickness-reduced surface adjacent to the flank from the lower surface side, and a contact surface adjacent to the thickness-reduced surface from the lower surface side; and
in a section orthogonal to the cutting edge, an angle formed by a virtual plane parallel to a central axis passing through a center of the upper surface and a center of the lower surface and passing through the at least one cutting edge and the contact surface is larger than an angle formed by the virtual plane and the thickness-reduced surface.

2. The cutting insert according to claim 1, which is a cutting insert that can be mounted on a tool body of a milling tool, wherein
in a state of being mounted on the tool body, the contact surface is in contact with the tool body, and the thickness-reduced surface is not in contact with the tool body.

3. The cutting insert according to claim 1, wherein
the upper surface is a substantial polygon, which is rotationally symmetric with respect to the central axis, and has a plurality of corners including a first corner and a second corner adjacent to each other; and
the thickness-reduced surface is formed at a position facing an intermediate position between the first corner and the second corner on the peripheral side surface.

4. The cutting insert according to claim 1, wherein
the contact surface is formed into a substantially conical surface or a substantially columnar surface, and the thickness-reduced surface is formed into a substantially flat surface.

5. A milling tool comprising a tool body and a cutting insert on which the tool body is mounted, wherein
the cutting insert
has an upper surface, a lower surface on a side opposite to the upper surface, and a peripheral side surface that connects the upper surface and the lower surface;
an edge where the upper surface and the peripheral side surface intersect includes at least one cutting edge;
the peripheral side surface includes a flank adjacent to the at least one cutting edge, a thickness-reduced surface adjacent to the flank from the lower surface side, and a contact surface adjacent to the thickness-reduced surface from the lower surface side; and
the tool body is in contact with the contact surface and is not in contact with the thickness reduced surface.
